(19) United States
(12) Patent Application Publication
(10) Pub. No.: US 2006/0242243 A1
(43) Pub. Date: Oct. 26, 2006

(54) Communication device having function for automaticaly determining unsolicited e-mails

(76) Inventor: Fumiaki Matsumoto, Higashiosaka-shi (JP)

Correspondence Address: SNELL & WILMER LLP, 600 ANTON BOULEVARD, SUITE 1400, COSTA MESA, CA, 92626, US

(21) Appl. No.: 10/554,883

(22) PCT Filed: May 17, 2004
(86) PCT No.: PCT/JP04/06990

§ 371 Date: Oct. 28, 2005

(30) Foreign Application Priority Data
May 16, 2003 (JP) 2003-138894

(51) Int. Cl. G06F 15/16

(52) U.S. Cl. 709/206

(57) ABSTRACT

In a mobile telephone 100 having an email transmission and reception function, a control unit 106 acquires, from a history information recording unit 1082, history information of emails transmitted by the mobile telephone 100, and determines, based on the acquired history information whether a received email, which has the email address of the mobile telephone 100 as a transmission source, is in fact an email transmitted by the mobile telephone 100, thereby determining whether that email is an unsolicited email.

### TECHNICAL FIELD

The present invention relates to a communication device having an email transmission/reception function, and in particular, to a communication device including a function for identifying unsolicited email transmitted to a user from a undesired sender.

### BACKGROUND ART

In recent years, with the rapid development of communications technology and communications networks, the exchange of email via communications devices such as mobile telephones and the PCs (personal computers) has reached a point where it is being carried out vigorously and extensively, transcending the boundaries of region and national borders.

As a result, a user of one of these communications devices can easily and quickly exchange email with anyone in the world.

However, irresponsible businesses using communications networks to unilaterally transmit unsolicited email have recently emerged and continue to increase rapidly in number.

Here “unsolicited email” is used to mean email which is transmitted to the email addresses of an unspecified large number of users in possession of communications devices, email for persuading such users to buy products or services, or the like.

Should a user's communications device receive such unsolicited email without the user being aware that it is unsolicited email, the problem arises of a reception fee being superfluously claimed by the communications company for its reception, and the user having to pay for what is to him an unwanted service.

As a previous technology for solving this problem, a technique in which email addresses sourcing the transmission of unsolicited email are pre-recorded in the mail server managing email and in which the mail server deletes on reception any email from the recorded addresses is disclosed in Patent Document 1.

Using this technique, a user can be effectively protected against unsolicited email being mistakenly received by his communications device.

Patent Document 1: Laid Open Japanese Patent Application 2002-335288.

However, recently, the tricks used by the irresponsible businesses have been growing more and more elaborate. Irresponsible behavior in which the email address of the transmission source is used as the user email address in order to transmit unsolicited email, a technique known as impersonation, is being practiced by the irresponsible businesses, and the problem has arisen of the prior art described above being unable tackle this kind of irresponsible behavior.

### DISCLOSURE OF THE INVENTION

The present invention has an object of providing a communications device and a server able to identify unsolicited email that is using an “impersonated” email address as a transmission source.

The present invention is a communications device having an own-email address, a transmission function, and a reception functions, the communications device including: a history information acquiring unit operable to acquire history information of email transmitted by means of the transmission function; a received email determining unit operable to determine whether or not a received email that has the own-address as a transmission source email address is unsolicited email based on the acquired history information.

Here, the communications device may be a mobile telephone.

Further, the present invention may be a mail server having an email transmission and reception function, including: a history information recording unit operable to record history information of email transmitted by a user; and a received email determining unit operable to determine, based on the history information, whether or not a received email is unsolicited email based on the history information.

Using this mail server, unsolicited email using an “impersonated” email address as the transmission source email address can easily be distinguished as being unsolicited mail.

Here, the communications device may further include a deletion requesting unit operable to request an external mail server to delete the received email when the received email has been determined to be unsolicited email.

Since, according to this arrangement, received email determined to be unsolicited email can be automatically deleted, circumstances in which a user is forced to read unsolicited email can be effectively prevented from arising.

Here, the history information may include one or more email titles of the one or more emails transmitted by means of the transmission function, the received email determining unit may include a header information acquisition unit operable to acquire header information of the received email from the external email server, the header information including the transmission source email address and an email title, and when the transmission source email address included in the acquired header information matches the own-address and the email title included in the acquired header information fails to match any of the one or more email titles included in the history information, the received email determining unit may determine the received email to be unsolicited email.

Since, according to this arrangement, determination of unsolicited email can be carried out based solely on the received header information of the email, whether or not a received email is unsolicited email can be determined before the body of the email is received from the remote server. Therefore, circumstances in which, unbeknown to him, the user is made to receive the body of an unsolicited email for which he pays a needless transmission fee are effectively prevented from arising.

Here, the communications device may further include: a determination assessment value recording unit operable to record a determination assessment value table, the determination assessment value table indicating one-to-one correspondences between keywords included in received email already determined to be unsolicited email by the received email determining unit and determination assessment values each showing a degree of importance of a different one of the keywords in determining unsolicited email; and a keyword determining unit operable to a) extract one or more keywords from the received email whose transmission source email address is the own-address b) specify any keywords in the determination assessment value table that match the one or more extracted keywords, and c) determine whether or not the received email is unsolicited email based on the determination assessment values corresponding to the specified one or more keywords.

According to this arrangement, it is possible to determine unsolicited email by weighting representative key words included in received email already determined to be unsolicited email, and effective unsolicited email determination can be performed even for received email whose transmission source email address is not the own-email address.

Here, each determination assessment value may increase as an appearance count of the corresponding keyword in unsolicited email increases, and the keyword determination unit may determine that the received email is unsolicited email if a sum of the determination assessment values corresponding to the specified one or more keywords is larger than a predetermined threshold.

Since, according to this arrangement, unsolicited email can be determined by giving greater weight to keywords that appear more frequently in the header information of received emails already determined to be unsolicited email, it is possible to effectively distinguish unsolicited email as being unsolicited email, even for received email whose transmission source email address is not the own-email address.

Here the communications device may further include: a warning unit operable to warn a user when the received email has been determined to be unsolicited email by the keyword determination unit; and a deletion requesting unit operable to request, in response to an instruction from a user, an external mail server to delete the received email that has been determined to be unsolicited email.

Since, according to this arrangement, when the received email has been determined to be unsolicited email the user is notified to this effect, he can easily distinguish received email that is likely to be unsolicited email and have such received email deleted from the mail server as required.

Here, the communications device may further include a registering unit operable to additionally register, in the determination assessment value table, a one-to-one correspondence between a keyword included in the received email whose deletion has been requested and a determination assessment value based on the appearance count of the keyword.

Since, according to this arrangement, the information about keywords included in unsolicited email can be regularly updated, unsolicited email can be effectively distinguished and deleted from the mail server even when the irresponsible businesses which are the transmission source of the unsolicited email vary its content over time.

### BRIEF DESCRIPTION OF THE DRAWINGS

FIG. 1 is a function block diagram showing the composition of a mobile telephone 100;

FIG. 2 shows an example of history information;

FIG. 3 shows the format of transmitted/received emails;

FIG. 4 is a flow chart showing the operations of received email acquisition control processing performed by a control unit 106;

FIG. 5 is a function block diagram showing the composition of a mobile telephone 200;

FIG. 6 is a flow chart showing operations of unsolicited email determination processing carried out by a control unit 206; and

FIG. 7 shows an example of an unsolicited email-specifying keyword table.

### BEST MODE FOR CARRYING OUT THE INVENTION

### First Embodiment

(Composition)

The mobile telephone of the First Embodiment of the present invention is a mobile telephone provided with an unsolicited email distinguishing function.

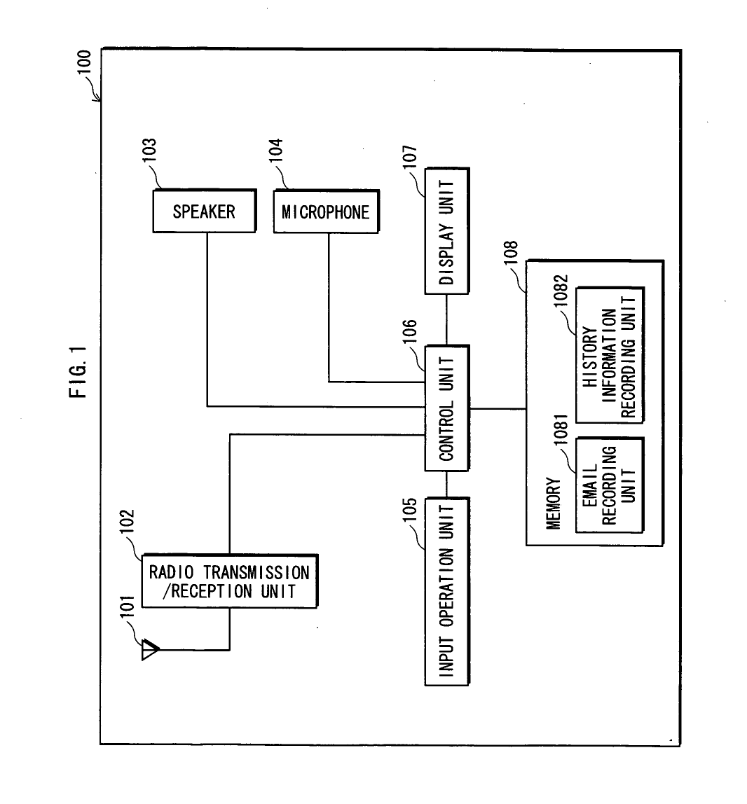

FIG. 1 is a function block diagram showing the composition of a mobile telephone 100 of an embodiment of the present invention. The mobile telephone 100 is, as shown in FIG. 1, composed of an antenna 101, a radio transmission/reception unit 102, a speaker 103, a microphone 104, an input operation unit 105, a control unit 106, a display unit 107, and a memory 108.

The radio transmission/reception unit 102 demodulates radio waves inputted via the antenna 101 to recover communications data and outputs the communications data to the control unit 106. Further, the radio transmission/reception unit 102 modulates communications data inputted by the control unit 106 and transmits them as radio waves via the antenna 101.

Here, “communications data” is used to mean data such as sound data from telephone calls, character data and image data from emails or the like.

The speaker 103 generates sound on the basis of the sound data inputted from the control unit 106.

The microphone 104 outputs sound inputted by the user as sound signals to the control unit 106.

The input operation unit 105 has various input keys, including alpha-numeric keys, an power on/off key, and a call key, receives various instructions (such as email reception instructions and email transmission instructions, for instance) and other types of data input (character input, for instance) from the user via the input keys, and outputs the received user instructions and input data to the control unit 106.

The display unit 107 displays characters and images on the basis of character data and image data inputted by the control unit 106.

The memory 108 is composed of an email recording unit 1081 and a history information recording unit 1082.

The email recording unit 1081 stores email received from outside the device via the radio transmission/reception unit 102.

The history information unit 1082 stores the email address that has been conferred on the mobile telephone 100 (referred to hereinafter as “the own-email address”) and stores history information.

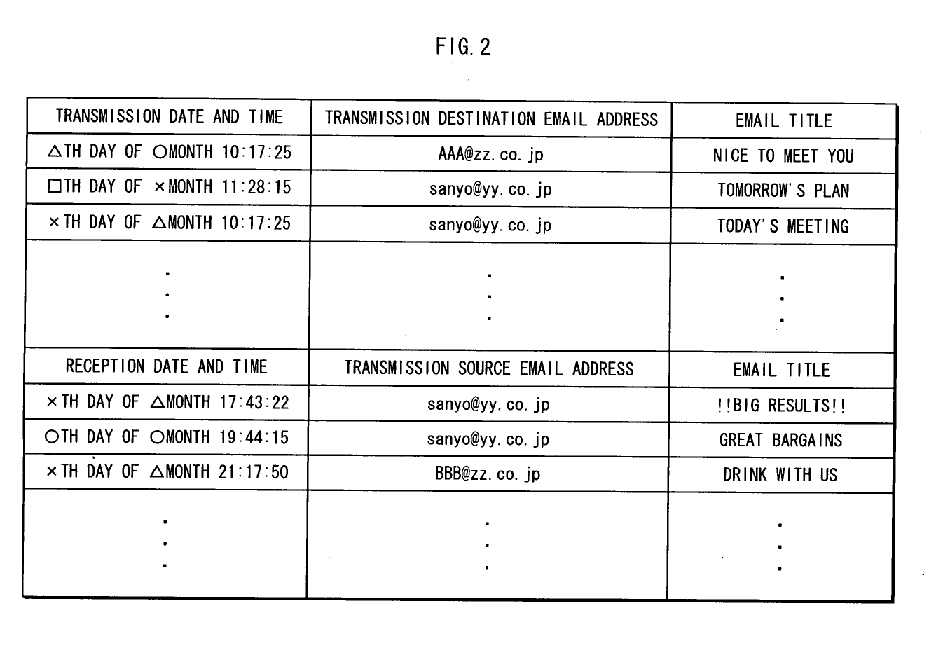

Here, “history information” is used to mean information that shows, a record of transmitted and received email, and specifically refers to information indicating correspondences between the transmission or reception dates and times, the transmission destination email address (in the case of transmission) or the transmission source email address (in the case of reception), and the title. FIG. 2 shows an example of the history information.

The control unit 106 is composed of a microprocessor, ROM (Read Only Memory) and RAM (Random Access Memory) and the like, and controls the whole of the mobile telephone 100 according to a control program stored in the ROM.

Further, an email program is stored in the ROM, and the control unit 106 carries out the following processing by activating and executing this email program.

(1) Process for Generating Email for Transmission

The mobile telephone 100 generates email for transmission based on character input of a transmission destination email address, an email title, an email body and the like, which are inputted by a user via the input operation unit 105.

(2) Process for Recording History Information

When the mobile telephone 100 transmits an email generated by means of the process for generating email for transmission of (1) to the transmission destination email address according to a transmit email instruction from the user, it records history information for the email (hereinafter “transmission history information”) in the history information recording unit 1082.

Note that the transmission history information may instead be recorded at an external mail server.

Further, when the mobile telephone 100 connects to the external mail server via the radio transmission/reception device 102 in response to an email reception instruction inputted by a user via the input operation unit and acquires header information of a received email from the external mail server, it records the history information of the email (hereinafter “reception history information”) based on the acquired header information in the history information recording unit 1082.

Note that the reception history information may instead be recorded at the external mail server.

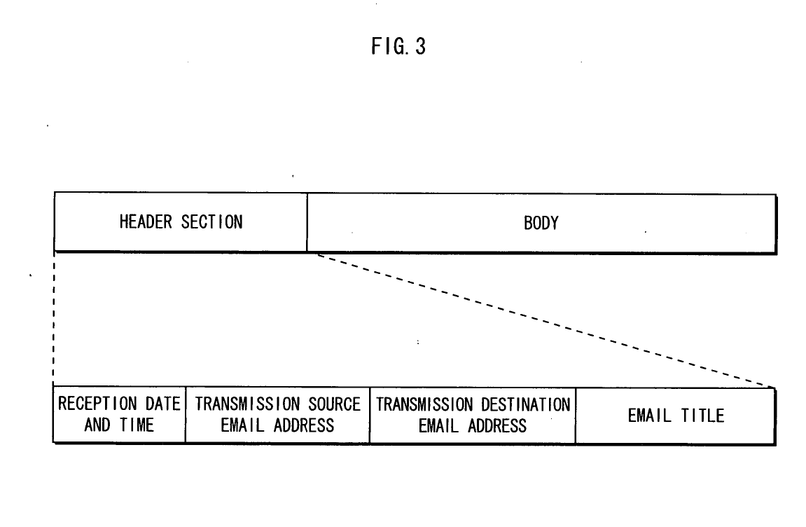

Here, “header information” is used to mean information described in the header section of the email and including a date and time the email was received by the mail server, email addresses of the transmission source and transmission destination, a title of the email, and transmission path information for the email. FIG. 3 shows the format of email that is transmitted and received. The email is, as shown in FIG. 3, composed of a header section and a data section, the header information being recorded in the header section and contents of the body of the email being recorded in the data section.

(3) Process for Controlling Acquisition of Unsolicited Email

The mobile telephone 100 determines whether or not the transmission source email address matches the own-email address based on the received header information of an email, and, if it matches, further determines whether or not the email title associated with the transmission source email address matches any of the email titles already recorded in the transmission history information. If the received email title fails to match one of the email titles of the transmission history information, the received email is determined to be “unsolicited email”, and the mobile telephone 100 carries out processing to delete it. Specifically, without itself acquiring the data section of the email determined to be unsolicited email from the receiving mail server, the mobile telephone 100 performs processing to cause the mail server to delete the received email, according to instruction via the radio reception/transmission unit 102.

(Operation)

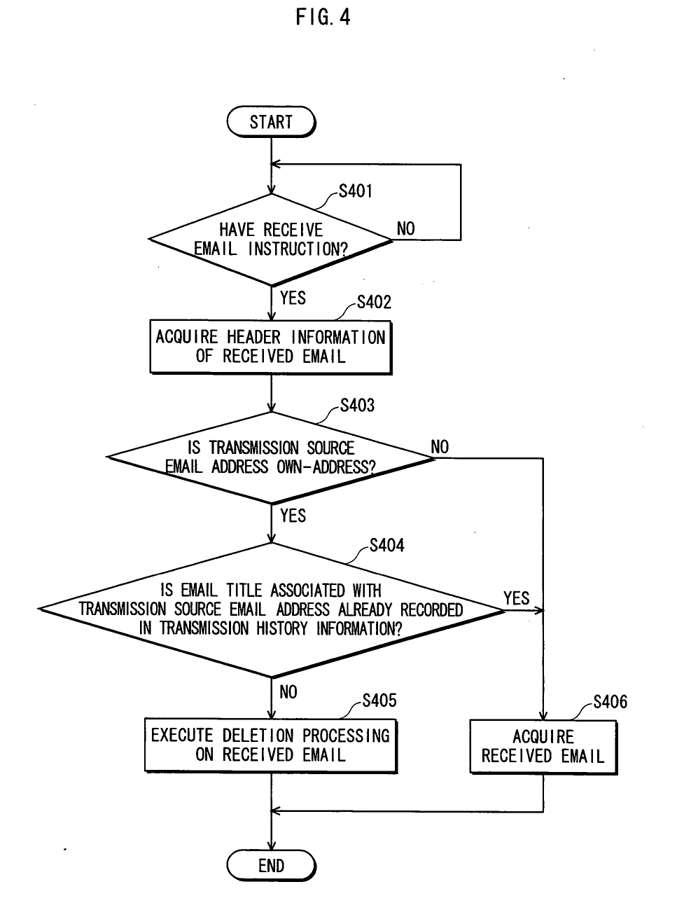

Operations of the received email acquisition control processing performed by the control unit 106 are described below. FIG. 4 is a flow chart showing these operations. The operations are described below with reference to FIG. 4.

When the control unit 106 has received an email reception instruction from the user via the input operation unit 105 (Step S401: Y), in compliance with the email reception instruction, the control unit 106 connects to the external mail server via the radio transmission/reception unit 102, and acquires the received header information of the email (Step S402) from the server via the radio transmission/reception unit 102. The control unit 106 then determines whether or not the transmission source of the received email is “named as being mobile telephone 100”. In other words, the control unit 106 determines whether or not the transmission source email address included in the acquired header information matches the own-email address recorded in the history information recording unit 1082 (Step S403). When the transmission source email address matches the own-mail address (Step S403: Y), the control unit 106 determines whether or not the email title associated with the transmission source email address matches one of the email titles already recorded in the in the transmission history information (Step S404).

When there is no match with any of the recorded email titles, (Step S404: N), the control unit 106 determines the received email to be “unsolicited email”, and executes processing to delete the received mail (Step S405).

When, in Step S403, the transmission source email address is not the own-email address (Step S403: N), or when in Step S404 there is a match with one of the recorded email titles (Step S404: Y), the control unit 106 communicates an email acquisition instruction to the radio transmission/reception unit 102, acquires the email via the radio transmission/reception unit 102 (Step S406), and records the acquired email in the email recording unit 1081.

### Second Embodiment

The mobile telephone of the Second Embodiment of the present invention further includes, in addition to the functions of the mobile telephone of the First Embodiment, an unsolicited email identifier function for email whose transmission source email address is not the “own-email address”.

In the description below, compositional elements identical to those of the mobile telephone 100 of the First Embodiment have identical numbers assigned to them, and a description of these compositional elements is omitted. The description below focuses on aspects of a mobile phone 200 that differ from the mobile phone of the mobile phone 100.

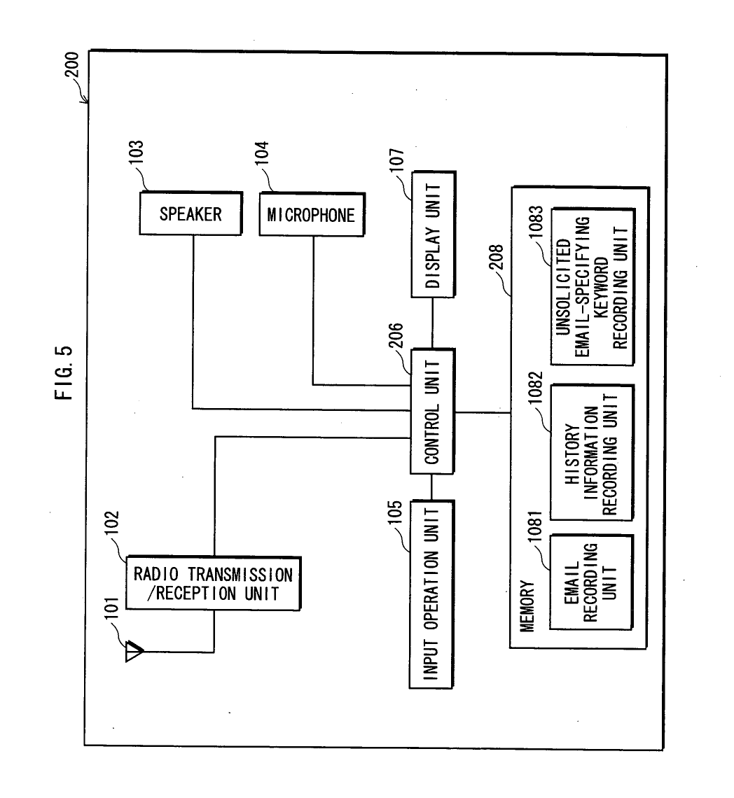

FIG. 5 is a function block diagram showing the composition of a mobile telephone 200. The mobile telephone 200 is, as shown in FIG. 5, composed of the antenna 110, the radio transmission reception unit 102, the speaker 103, the microphone 104, the input operation unit 105, a control unit 206, the display unit 107 and a memory 208.

The memory 208 is composed of the email recording unit 1081, the history information recording unit 1082, and an unsolicited email-specifying keyword recording unit 1083.

The unsolicited email-specifying keyword recording unit 1083 has recorded thereon an unsolicited email-specifying keyword table and a threshold value of an unsolicited email-determining assessment value.

Here, “unsolicited email-specifying keyword table” is used to mean a table showing the unsolicited email-specifying keywords and corresponding appearance frequencies and weighting coefficients.

“Unsolicited email-specifying keyword” is used to mean a keyword included in the header information of an email already determined to be “unsolicited email” by the control unit 206 via the unsolicited email determination processing described below. The “keyword” is a combination of specified characters (such as a group of kanji, katakana, hiragana, roman letters, numbers, or symbols, or some combination of these) included in the header information. The keyword may be limited to being a specific item of the header information, such as a word in the email title, for example.

“Appearance count” is used to mean the cumulative number of appearances of an unsolicited email-specifying keyword in the header information of emails already determined to be unsolicited email.

“Weighting coefficient” is used to mean a coefficient whose value increases in ascending order of unsolicited email-specifying key word appearance count.

“Unsolicited email determining assessment value” is used to mean a value calculated by multiplying the unsolicited email-specifying keyword appearance count with the corresponding weighting coefficient, the value of the weighting coefficient being dependent on the rank of a keyword in the keyword appearance count ranking.

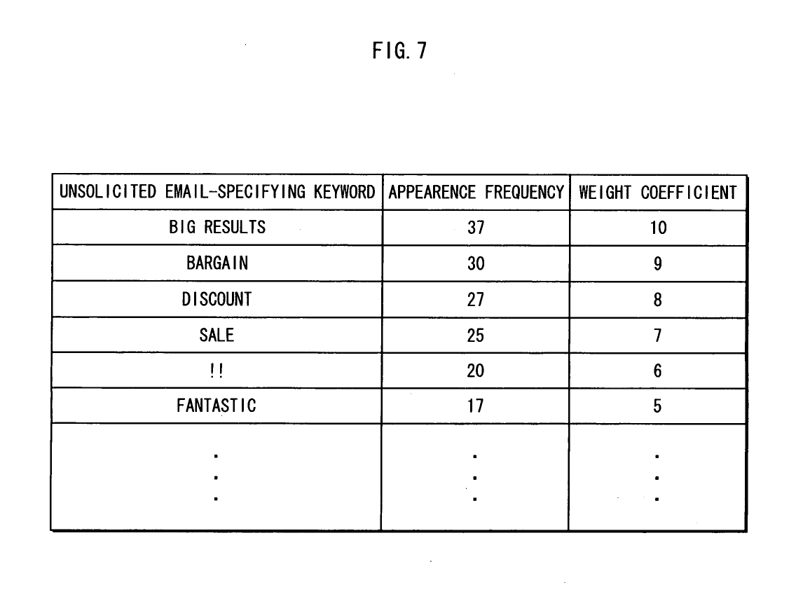

FIG. 7 shows an example of the unsolicited email-specifying key word table.

The control unit 206 is composed of a microprocessor, ROM (Read Only Memory), RAM (Random Access Memory), and the like, and controls the mobile telephone 100 according to instructions stored in the ROM.

Further, an email program is stored in the ROM, and the control unit 206 carries out a process for generating email for transmission, a process for recording history information, and a process for determining unsolicited email, by activating and executing the email program.

As the process for generating email for transmission and the process for recording history information are the same as those of the First Embodiment, a description of these processes is omitted here, and only the process for determining unsolicited email is described below.

The control unit 206 determines whether or not the transmission source email address matches the own-email address based on the received header information of the email.

Further, when the transmission source email address matches the own-email address, the control unit 206 further determines whether or not the email title associated with the transmission source email address matches an email title already recorded in the transmission history information. When there is no match, the control unit 206 determines the received email to be “unsolicited email”, extracts one or more keywords from the header information included in the email, and, after supplementary registration of the one or more extracted keywords in the unsolicited email-specifying keyword table recorded in the unsolicited email-specifying keyword recording unit 1083, carries out processing to delete the received email.

Here “supplementary registration” is used to mean that i) when an extracted keyword is not already registered in the unsolicited email-specifying keyword table, the extracted keyword is newly registered, or ii) when an extracted keyword is already registered, the appearance count of the that keyword is updated, and, based on the appearance count rank after this update, the weighting coefficient of that keyword is updated (if there is no change in the ranking, the weighting coefficient is not updated).

Further, in the above processing, when the email title is not registered in the transmission history information, the control unit 206 determines that there is no match.

Further, as the deletion processing is the same as for the First Embodiment, its description is omitted.

When, on the other hand, the transmission source email address does not match the own-email address, the control unit 206 extracts one or more keywords included in the header information of the received email, and specifies each unsolicited email-specifying keyword which matches an extracted keyword by comparing each extracted keyword with the unsolicited email-specifying keywords registered in the unsolicited email-specifying keyword table. The control unit 206 then calculates an unsolicited email-determining assessment value for each specified unsolicited email-specifying keyword, and further calculates a total of the unsolicited email-determining assessment values (hereinafter referred to as a “total assessment value”). When the calculated total assessment value exceeds a threshold value of the unsolicited email-determining assessment value, which is recorded in the unsolicited email-specifying keyword recording unit 1083, the control unit 206 causes the display unit 107 to display the header of the received email together with a warning message to the effect that “this email has been determined to be unsolicited email”.

If a request to delete the email is given from the user via the input operation unit 105, the control unit 206 extracts keywords included in the header information of the email and, after supplementary registration of the extracted keywords in the unsolicited email-specifying keyword registration table recorded in the unsolicited email-specifying keyword recording unit 1083, carries out processing to delete the email.

(Operation)

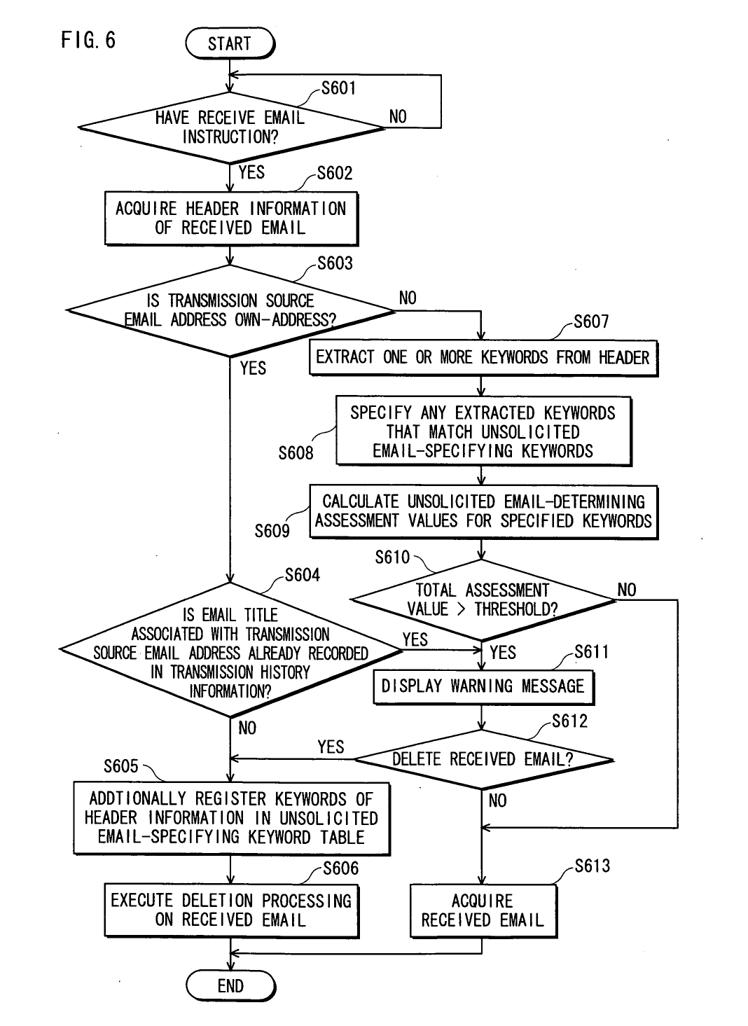

The operations of unsolicited email determination processing carried out by the control unit 206 are described below. FIG. 6 is a flow chart showing these operations. These operations are described with reference to FIG. 6.

If the control unit 206 has an email reception instruction from the user via an input unit 105 (Step S601: Y), in accordance with the email receive instruction, the control unit 206 connects to the external mail server via the radio transmission/reception unit 102, acquires the header information of the received email from the mail server via the radio transmission/reception unit 102 (Step S602), and determines whether or not the transmission source of the received email is the mobile telephone 200 on the basis of whether or not transmission source email address included in the acquired header information matches the own-email address recorded in the history information recording unit 1082 (Step S603). When the transmission source is itself (Step S603:Y), the control unit 206 determines whether or not the email title associated with the transmission source email address matches one of the email titles recorded in the transmission history information based on the transmission history information recorded in the history information recording unit 1082 (Step S604).

When there is no match with any of the recorded email titles (Step S604:N), the control unit 206 extracts keywords included in the header information of the email and carries out supplementary registration of the various extracted keywords in the unsolicited email-specifying key word table recorded in the unsolicited email-specifying key word recording unit 1083 (Step S605), and further carries out processing to delete the received email (Step S606).

In Step S603, when the transmission source email address is not the own-email address (Step S603: N), the control unit 206 extracts keywords included in the header information of the received email (Step S607), and specifies, from among the registered email-specifying keywords, any unsolicited email-specifying keywords which matches the extracted keywords by comparison with the unsolicited email-specifying keywords registered in the unsolicited email-specifying keyword table (Step S608). The control unit 206 then calculates an unsolicited email determining assessment value for each specified unsolicited email-specifying key word (Step S609), further calculates a total of the unsolicited email-specifying keyword assessment values (hereinafter, referred to as a “total assessment value”), and determines whether or not the calculated total assessment value is greater than a threshold value of the unsolicited email-determining assessment value which is recorded in the unsolicited email-specifying key word recording unit 1083 (Step S610).

When the calculated total assessment value is larger than the threshold (Step S610: Y), the control unit 206 causes the display unit 107 to display the header of the received email and a warning message to the effect that “this email has been determined to be unsolicited email” (Step S611), and, on obtaining an email deletion request from the user via the input operation unit 105 (Step S612: Y), switches to the processing of Step S605.

In Step S610, when the calculated total assessment value is not as large as the threshold value of the unsolicited email-specifying assessment value (Step S610: N), or, in Step S612 when there has been a request from the user not to delete the received email (Step S612: N), the control unit 206 communicates an acquisition instruction for the received email to the radio transmission/reception unit 102, and acquires the email from the external mail server via the radio transmission/reception unit 102 (Step S613).

(Supplementary Remarks)

The mobile telephone of the present invention has been described based on the embodiments. However, the present invention is not of course limited to these embodiments.

(1) In the First and Second Embodiments, the process for controlling acquisition of unsolicited email and the process for determining unsolicited email were described as being performed by a mobile phone. However, the device is not limited to being a mobile phone, but may be any other device provided it is a communications device which includes the control unit 106 and the memory 108, or the control unit 206 and the memory 208, as compositional elements. Examples of such a device include a PDA (Personal Digital Assistant), a PC (Personal Computer) having an email transmission and reception function, and a mail server.

Note that, in the mail sever, a received email, history information, an unsolicited email-specifying keyword table, and a threshold value of unsolicited email-determining assessment value would be recorded in memory for each user.

(2) In the First and Second Embodiments, the communications device was described as determining “unsolicited email” based on whether or not the email titles matched, but other methods may be used. For example, the time of transmission of an email may be recorded in the transmission information of the communications device, and determination of “unsolicited email” performed based on whether or not the time at which the transmission source received the header information of the email from the communications device is within a predetermined time period of the last time the communications device transmitted an email addressed to itself.

(3) In the First and Second Embodiments, in Step S403 of FIG. 4 and Step S603 of FIG. 6, the communications device was described as determining whether or not the transmission source of the received email was itself based on whether or not the transmission source email address matched the own-email address recorded in the history information recording unit 1082. However, the communications device may determine whether or not the transmission source is named as being the communications device itself on the basis of whether or not the transmission source email address and the transmission destination address which are included in the header information of the received email match each other.

(4) In the First and Second Embodiments, the processing of Step S611 and of Step S612 of FIG. 6 may be added between Step S404 and Step S405 of FIG. 4 and between Step S604 and Step S605 of FIG. 6 respectively, the processing of Step S405 and the processing of Step S605 being performed in the respective embodiments when the decision in Step S612 is “YES” and the processing of Step S406 and Step S613 being performed when the decision is “NO”.

(5) In the First and Second Embodiments, in Step S402 of FIG. 4 and in Step S602 of FIG. 6, the communications device was described as acquiring the header information of a received email, but the communications device may acquire the email body in addition to the header information.

Further, the transmitted email body may be included in the transmission history information, and instead of carrying out the processing of Step S404 of FIG. 4 and Step S604 of FIG. 6, the communications device may determine whether or not both the email title and the email body match the email title and email body already registered in the transmission history information.

This enables determination of unsolicited email to be carried more accurately.

(6) In the Second Embodiment, in Step S605 of FIG. 6, determination of unsolicited email was described as being performed based on keywords included in the header information of the received email as indicated in Step 607. However, instead of keywords in the header information, or in addition to keywords in the header information, determination of unsolicited email may be performed on the basis of keywords included in the body of the received email.

With this arrangement, even when, for example, unsolicited email that is impossible to distinguish as such solely by the email title has been transmitted, the unsolicited email can be distinguished based on the content of the email body, and the efficiency of the unsolicited email detection can therefore be increased.

Further, instead of being based on keywords included in the header information, the processing of Step S605 and Steps S607 to S609 may be based on email titles.

(7) In the Second Embodiment the determination of unsolicited email was described as being performed by applying weightings that depended on the appearance count ranking of the unsolicited email-specifying keywords, but the application of weightings may be performed via a different method.

For example, the weighting coefficients may be set by the user inputting a coefficient for each unsolicited email-specifying keyword.

(8) In the Second Embodiment, the correspondence between each the unsolicited email-specifying keyword and the appearance count and weighting coefficient of the same keyword were described as being registered in the unsolicited email-specifying keyword table. However, registration times and dates may further be registered, and, after registration, the control unit 206 may delete from the unsolicited email-specifying keyword table unsolicited email-specifying keywords whose registration time and date indicates that a predetermined amount of time has passed.

With this arrangement, even for unsolicited email whose content is constantly changing, unsolicited email can be adequately determined based on keywords commonly included in recently transmitted unsolicited email.

### INDUSTRIAL APPLICABILITY

The communications device of the present invention can be applied in a technique for identifying unsolicited email in a communications device that includes an email transmission and reception function.

1. A communications device having an own-email address and transmission and reception functions for transmitting and receiving email via an external mail server, the communications device comprising:
a history information acquiring unit operable to acquire history information of emails transmitted using the transmission function;
a received email determining unit operable to a) acquire, from the external mail server, header information of an email that has been received by the external mail server, the header information including attribute information of the received email, and b) when a transmission source email address is the own-email address determine whether or not the received email is unsolicited email by comparing the header information and the acquired history information.

2. The communications device of claim 1, further comprising a deletion requesting unit operable to request an external mail server to delete the received email when the received email has been determined to be unsolicited email.

3. The communications device of claim 2, wherein
the history information includes one or more email titles of the one or more emails transmitted using the transmission function,
the header information includes the transmission source email address and an email title, and
when the transmission source email address is the own-email address, the received email determining unit determines the received email to be unsolicited email if the email title in the acquired header information fails to match any of the one or more email titles included in the history information.

4. The communications device of claim 1, further comprising
a determination assessment value recording unit operable to record a determination assessment value table, the determination assessment value table indicating one-to-one correspondences between keywords included in the header information of received emails already determined to be unsolicited email by the received email determining unit and determination assessment values each showing a degree of importance of a different one of the keywords in determining unsolicited email; and
a keyword determining unit operable to a) when the transmission source email address of the received email is not the own-email address, extract one or more keywords from the received email b) specify any keywords in the determination assessment value table that match the one or more extracted keywords, and c) determine whether or not the received email is unsolicited email based on the determination assessment values corresponding to the specified one or more keywords.

5. The communications device of claim 4, wherein
each determination assessment value increases as an appearance count of the corresponding keyword in unsolicited email increases, and
the keyword determination unit determines that the received email is unsolicited email if a sum of the determination assessment values corresponding to the specified one or more keywords is larger than a predetermined threshold.

6. The communications device of claim 4, further comprising:
a warning unit operable to warn a user when the received email has been determined to be unsolicited email by the keyword determination unit; and
a deletion requesting unit operable to request, in response to an instruction from a user, an external mail server to delete the received email that has been determined to be unsolicited email.

7. The communications device of claim 6, further comprising a registering unit operable to additionally register, in the determination assessment value table, a one-to-one correspondence between a keyword included in the received email whose deletion has been requested and a determination assessment value based on the appearance count of the keyword.

8. The communication device of claim 1, wherein
the communication device is a mobile telephone.

9. A mail server having transmission and reception functions and serving a communications device, comprising:
a history information recording unit operable to record history information of email transmitted by a user of the communications device; and
a received email determining unit operable to determine, based on the history information, whether or not a received email that is addressed to the communications device and has an email address of the communications device as a transmission source email address is unsolicited email.

10. The communications device of claim 5, further comprising:
a warning unit operable to warn a user when the received email has been determined to be unsolicited email by the keyword determination unit; and
a deletion requesting unit operable to request, in response to an instruction from a user, an external mail server to delete the received email that has been determined to be unsolicited email.

11. The communication device of claim 2, wherein the communication device is a mobile telephone.

12. The communication device of claim 3, wherein the communication device is a mobile telephone.

13. The communication device of claim 4, wherein the communication device is a mobile telephone.

14. The communication device of claim 5, wherein the communication device is a mobile telephone.

15. The communication device of claim 6, wherein the communication device is a mobile telephone.

16. The communication device of claim 7, wherein the communication device is a mobile telephone.
